(19) United States
(12) Patent Application Publication
(10) Pub. No.: US 2010/0205659 A1
(43) Pub. Date: Aug. 12, 2010

(54) INFORMATION MANAGEMENT SYSTEM, INFORMATION PROCESSING APPARATUS AND COMPUTER READABLE MEDIUM STORING INFORMATION PROCESSING PROGRAM

(75) Inventor: Hiroaki SUZUKI, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/705,075

(22) Filed: Feb. 12, 2010

(30) Foreign Application Priority Data
Feb. 12, 2009 (JP) 2009-030530

(51) Int. Cl. H04L 9/32

(52) U.S. Cl. 726/5

(57) ABSTRACT

An information management system includes first and second information processing apparatuses. The first information processing apparatus includes: an invalidation unit configured to invalidate operation at the first information processing apparatus if input terminal password information is different from correct terminal password information; and a first releasing unit configured to release an invalidation of the operation based on an invalidation releasing process. The second information processing apparatus includes: a determination unit configured to determine whether target information is in a limited state in which a process to the target information is limited at the second information processing apparatus; and a second releasing unit configured to perform the invalidation releasing process if correct limitation releasing password information is input. The invalidation releasing process includes: releasing the limited state of the target information; and releasing the invalidation of the operation of the first information processing apparatus.

### CROSS-REFERENCE TO RELATED APPLICATIONS

This application claims priority from Japanese Patent Application No. 2009-030530 filed on Feb. 12, 2009, the entire contents of which are incorporated herein by reference.

### TECHNICAL FIELD

The present invention relates to an information management system, an information processing apparatus provided in the information management system, and a computer program for the information processing apparatus. More specifically, the present invention relates to an information management system including an information processing apparatus configured to process confidential information.

### BACKGROUND

Recently, various information processing apparatus have been reduced in its size and weight, which generally enables a user to always bring a terminal device including a memory storing various information and to browse the information as needed. In association with this occasion, there is a need for an improvement to assure security of the information in the terminal device brought by the user.

A related art proposes a system including a terminal device and a key device carried by a user, and when the terminal device can not communicate with the key device, the terminal device is set to a locked state (an operation disabled state). Further, only if an authentication procedure at the terminal device is succeeded, the lock state is allowed to be released. Accordingly, the reduction of security can be prevented caused by loss of the key device.

However, the system described above provides the terminal device capable of performing the authentication, but can not prevent the reduction of security caused by the loss of the terminal device per se.

Since the terminal device is carried by the user, the terminal device may be lost during carry of the terminal device by the user. Therefore, in order to enhance the security of the information in the terminal device premising this occasion, it is necessary to set an invalidated state in which the authentication at the terminal device is disabled.

In the above technique, for example, if the terminal device is set to the invalidated state irrespective of whether the authentication procedure is permitted or prohibited, the user has no measure to release the invalidated state after the terminal device is set to the invalidated state. Consequently, in order to again allow the use of the terminal device in the invalidated state, for example, it is necessary to bring the terminal device in the invalidated state in a manufacturer so as to release the invalidated state.

### SUMMARY

However, in this case, since the user can not use the terminal device while the terminal device is brought in the manufacturer, the convenience is reduced. Further, it requires a dedicated device for releasing the invalidated state. Yet further, it requires extra fees for releasing the invalidated state.

The present invention was made in consideration with the above circumstances, and an example of an object thereof is to provide an information management system, an information processing apparatus provided in the information management system and a computer program for the information processing apparatus, capable of enhancing the convenience of the terminal device by releasing the invalidation thereof even when operation to the terminal device is invalidated to ensure the security of the information stored in the terminal device carried by the user.

According to a first aspect of the invention, there is provided an information management system comprising: a first information processing apparatus; and a second information processing apparatus, wherein the first information processing apparatus comprises: a storage unit configured to store: target information which is a target of a process at the first information processing apparatus; and invalidation information which indicates whether an operation performed at the first information processing apparatus is invalidated at the first information processing apparatus; a first input unit configured to receive an input of terminal password information; an invalidation unit configured to invalidate the operation performed at the first information processing apparatus if the input terminal password information is different from correct terminal password information; and a first releasing unit configured to release an invalidation of the operation in a case in which the operation is invalidated by the invalidation unit, based on an invalidation releasing process performed by the second information processing apparatus, and wherein the second information processing apparatus comprises: a determination unit configured to obtain the invalidation information stored in the first information processing apparatus, and to determine whether the target information is in a limited state based on the obtained invalidation information, the limited state in which the process to the target information is limited at the second information processing apparatus; a second input unit configured to receive an input of a limitation releasing password information for releasing the limited state when the target information is in the limited state; and a second releasing unit configured to perform the invalidation releasing process if correct limitation releasing password information is input, the invalidation releasing process comprising: a limited state releasing process for releasing the limited state of the target information; and an operation invalidation releasing process for releasing the invalidation of the operation of the first information processing apparatus when the operation is invalidated.

According to a second aspect of the invention, there is provided a second information processing apparatus provided in an information management system that comprises a first information processing apparatus and the second information processing apparatus, said second information processing apparatus comprising: a determination unit configured to obtain invalidation information which indicates whether an operation performed at the first information processing apparatus is invalidated at the first information processing apparatus and which is stored in the first information processing apparatus, and to determine whether target information which is stored in the first information processing apparatus and which is a target of a process at the first information processing apparatus is in a limited state based on the obtained invalidation information, the limited state in which the process to the target information is limited at the second information processing apparatus; and a second releasing unit configured to perform an invalidation releasing process if correct limitation releasing password information for releasing the limited state when the target information is in the limited state is input, the invalidation releasing process comprising: a limited state releasing process for releasing the limited state of the target information; and an operation invalidation releasing process for releasing the invalidation of the operation of the first information processing apparatus when the operation is invalidated.

According to a third aspect of the invention, there is provided a first information processing apparatus provided in an information management system that comprises the first information processing apparatus and a second information processing apparatus, said first information processing apparatus comprising: a storage unit configured to store: target information which is a target of a process at the first information processing apparatus; and invalidation information which indicates whether an operation performed at the first information processing apparatus is invalidated at the first information processing apparatus; a first input unit configured to receive an input of terminal password information; an invalidation unit configured to invalidate the operation performed at the first information processing apparatus if the input terminal password information is different from correct terminal password information; and a first releasing unit configured to release an invalidation of the operation in a case in which the operation is invalidated by the invalidation unit, based on an invalidation releasing process performed by the second information processing apparatus.

According to a fourth aspect of the invention, there is provided a computer readable medium having an information processing program for a second information processing apparatus provided in an information management system that comprises a first information processing apparatus and the second information processing apparatus, said program being stored on the computer readable medium, readable by a computer, and when executed by the computer, causing the computer to perform operations comprising: obtaining invalidation information which is stored in the first information processing apparatus and which indicates whether an operation performed at the first information processing apparatus is invalidated at the first information processing apparatus, and to determining whether target information which is stored in the first information processing apparatus and which is a target of a process at the first information processing apparatus is in a limited state based on the obtained invalidation information, the limited state in which the process to the target information is limited at the second information processing apparatus; and performing an invalidation releasing process if correct limitation releasing password information for releasing the limited state when the target information is in the limited state is input, wherein the invalidation releasing process comprising: performing a limited state releasing process for releasing the limited state of the target information; and performing an operation invalidation releasing process for releasing the invalidation of the operation of the first information processing apparatus when the operation is invalidated.

According to a fifth aspect of the invention, there is provided a computer readable medium having an information processing program for a first information processing apparatus which is provided in an information management system comprising the first information processing apparatus and a second information processing apparatus and which comprises a storage unit configured to store target information being a target of a process at the first information processing apparatus and invalidation information indicating whether an operation performed at the first information processing apparatus is invalidated at the first information processing apparatus and a first input unit, said program being stored on the computer readable medium, readable by a computer, and when executed by the computer, causing the computer to perform operations comprising: invalidating the operation performed at the first information processing apparatus if terminal password information input to the first input unit is different from correct terminal password information; and releasing an invalidation of the operation in a case in which the operation is invalidated, based on an invalidation releasing process performed by the second information processing apparatus.

### BRIEF DESCRIPTION OF DRAWINGS

FIGS. 1A and 1B show schematic diagrams of an information management system according to an embodiment of the invention, in which FIG. 1A is a block diagram showing an entire configuration of the information management system, and FIG. 1B is a plan view of a terminal device provided in the information management system;

FIGS. 2A and 2B are block diagrams showing detailed configuration, in which FIG. 2A shows a block diagram showing a detailed configuration of a personal computer according to the embodiment, and FIG. 2B is a block diagram showing a detailed configuration of the terminal device according to the embodiment;

FIG. 3 is a flowchart showing an entire operation of the terminal device according to the embodiment;

FIGS. 4A and 4B are flowcharts showing a detailed operation of the terminal device according to the embodiment, in which FIG. 4A is a flowchart showing a content selection/display operation at the terminal device, and FIG. 4B is a flowchart showing a password authentication operation at the terminal device;

FIG. 5 is a flowchart showing an entire operation of the personal computer according to the embodiment; and

FIG. 6 is a flowchart showing a password authentication operation at the personal computer.

### DESCRIPTION

Embodiments of the invention will be described hereinafter with reference to accompanying the drawings. In the embodiments, the invention is applied to an information management system including a personal computer as a second information processing apparatus and a portable terminal device as a first information processing apparatus connected to the personal computer, and the exemplified portable terminal device uses a display device using, for example, an electrophoretic method. However, the present invention should not be construed as being limited thereto.

(I) Entire Configuration and Operations

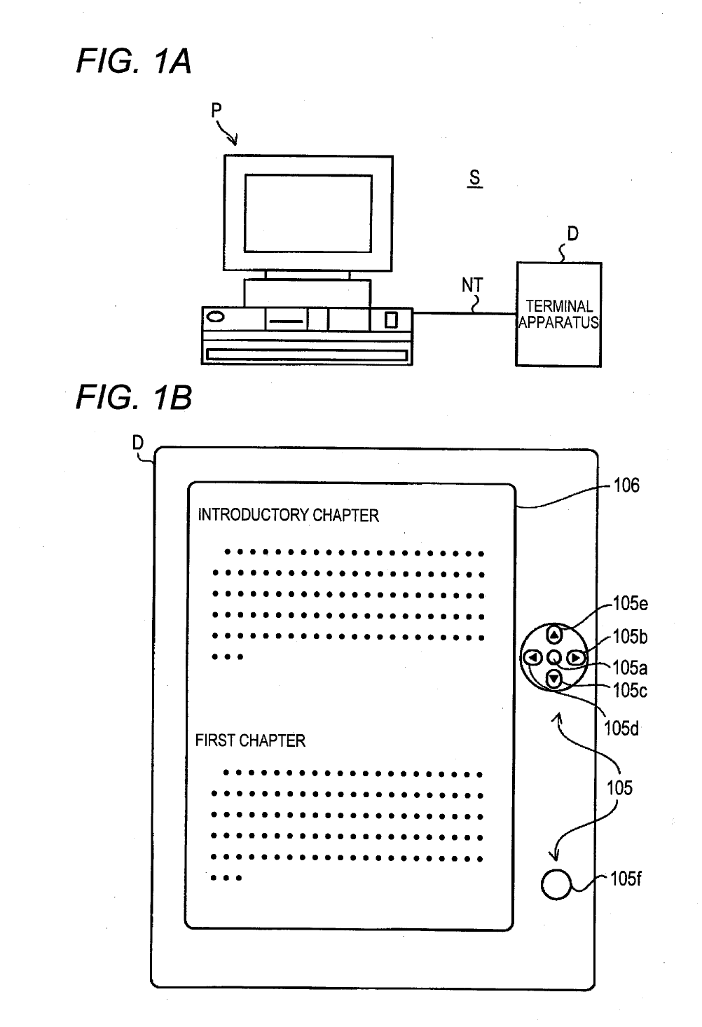

Firstly, an entire configuration of the information management system according to the embodiment will be described with reference to FIG. 1A.

As shown in FIG. 1A, an information management system S according to the embodiment includes a personal computer P and a terminal device D which are connected to each other through a network NT, for example, according to a USB (Universal Serial Bus) standard or a LAN (Local Region Network) standard. Data communication between the personal computer P and the terminal apparatus D may be performed using a memory card described later. Further, the personal computer P and the terminal device D are mutually authenticated in advance for the connection therebetween.

In this configuration, information such as documents which is produced at the personal computer P as a display target is output to the terminal device D through the network NT to be displayed on the terminal apparatus D. Hereinafter, the information such as the documents is simply referred to as a “content.”

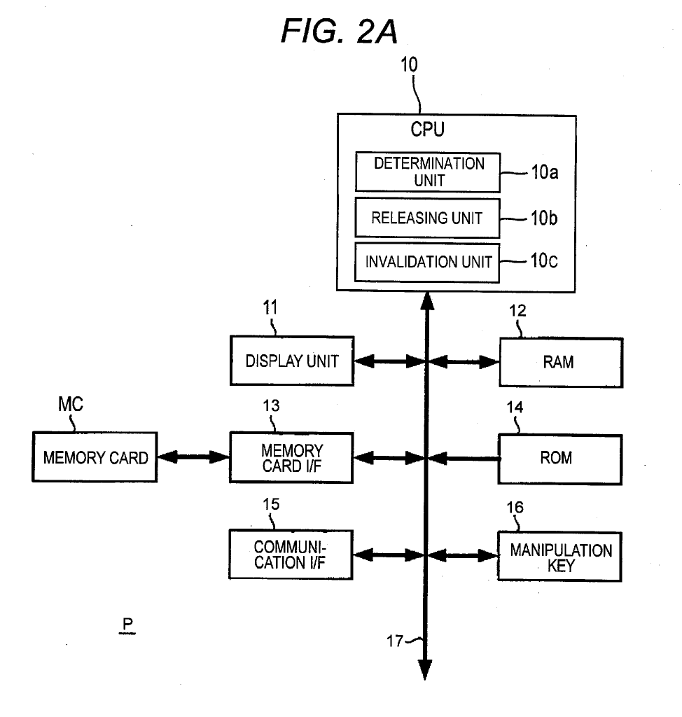

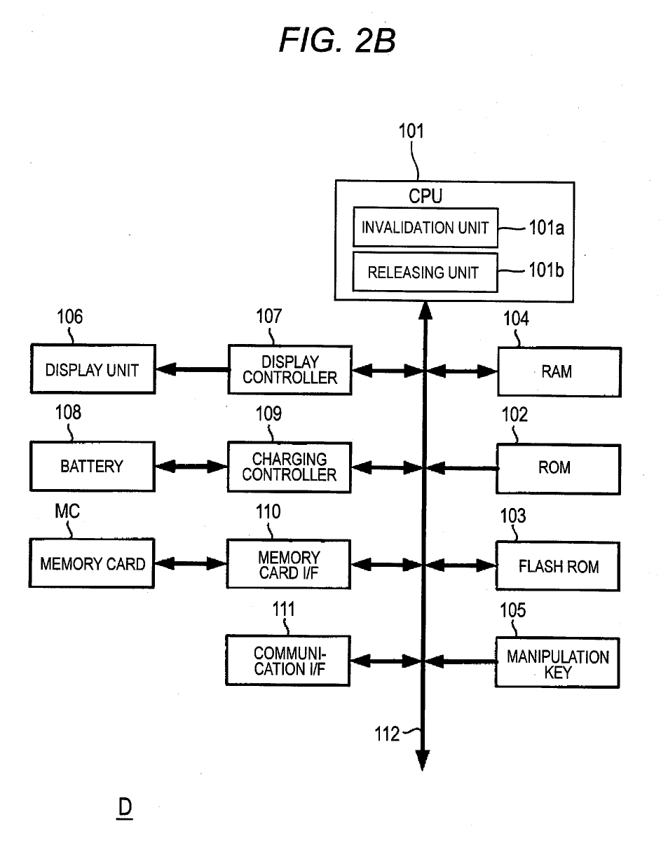

Next, the details of the personal computer P according to the embodiment are described with reference to FIG. 2A.

The personal computer P according to the embodiment operates as a management device configured to perform operations described later for managing the terminal device D which is mutually authenticated, for example, an operation invalidated state of the terminal device D, so as to ensure security of the content stored in the terminal device D.

Specifically, as shown in FIG. 2A, the personal computer P according to the embodiment includes: a CPU (Central Processing Unit) 10, a display unit 11, a RAM (Random Access Memory) 12, a memory card I/F (interface) 13, a ROM (Read Only Memory) 14, a communication I/F 15, and a manipulation unit 16. The CPU 10 has the functions of a determination unit 10a as an example of a determination unit, a releasing unit 10b as an example of a second releasing unit, and an invalidation unit 10c, so as to control the personal computer P as a whole and to perform an operation of the personal computer P of the embodiment to be described later. The display unit 11 is a liquid crystal display or the like, and is configured to display information such as information required for the operations of the personal computer P. The RAM 12 temporally stores data required for a control process performed by the CPU 10. The memory card I/F 13 includes, for example, a memory card drive, and is configured to perform data write and read to a memory card MC inserted into the memory card drive as an example of recording medium, based on the instruction from the CPU 10. The ROM 14 is an example of a second storage unit configured to store, for example, various control programs for executing the operations as the personal computer P of the embodiment, data such as user settings, and/or various types of firmware. The communication I/F 15 is an example of a refusal instruction unit and configured to allow a connection between the personal computer P and the terminal device D through the network NT so as to perform data communication (data transmission and reception) therebetween. The manipulation unit 16 is an example of a second input unit configured to supply an instruction from the user to the CPU 10 as instruction information, and includes has a mouse, a keyboard or the like (not shown). The CPU 10 is connected to the display unit 11, the RAM 12, the memory card I/F 13, the ROM 14, the communication I/F 15 and the manipulation unit 16 via a bus 17.

In addition to the functions described above, the personal computer P further has functions to convert various formats of the content to be displayed on the terminal device D into a format for the display, and to store the converted content into the memory card MC or to transmit the converted content to the terminal device D.

Next, the terminal device D according to the embodiment will be described with reference to FIGS. 1B and 2B.

As shown in FIGS. 1B and 2B, the terminal device D according to the embodiment includes: a CPU 101, a ROM 102, a flash ROM 103, a RAM 104, manipulation keys 105, a display unit 106, and a display controller 107. The CPU 101 is an example of a state changing unit, and has a functions of an invalidation unit 101a as an example of an invalidation unit and a releasing unit 101b as an example of a first releasing unit, so as to control the terminal device D as a whole and to perform an operation of the terminal device D of the embodiment to be described later. The ROM stores firmware or the like. The flash ROM 103 is a nonvolatile memory an example of a fixed storage unit, and stores a variety of control programs for performing an operation as the terminal apparatus D according to the embodiment, data such as user settings, the content displayed on the display unit 106 such as the documents, etc. The RAM 104 temporarily stores data required for a control process of the CPU 101. The manipulation keys 105 is an example of a first input unit and includes a cursor key to be described later, a determination key and a power switch, and provides instructions from a user to the CPU 101 as instruction information. The display unit 106 includes a display panel, for example, the electrophoretic display panel or the liquid crystal display panel, and is configured to display on a screen thereof the content transmitted from the personal computer P. The display controller 107 is configured to control display on the display unit 106 based on instructions from the CPU 101.

The manipulation keys 105 specifically includes: an up key 105e and a down key 105c which are manipulated for moving (scrolling) a document displayed on the display unit 106, for example, vertically upwards or vertically downwards; a previous key 105d and a next key 105b which are manipulated for moving the document to a previous page and a next page for every page, respectively; the determination key 105a which is manipulated for determining results of various manipulations; and the power switch 105f. Herein, the cursor key includes the up key 105e, the down key 105c, the previous key 105d and the next key 105b.

The flash ROM 103 stores in a nonvolatile manner an invalidated state flag, for example, of two bits, which indicates whether to receive the operation of any of the manipulation keys 105 as the terminal device D when the corresponding manipulation key 105 is operated. Specifically, the flash ROM 103 stores an invalidated state flag having, for example, a value “00” if the content is in a “lock released state” described later at the terminal device D and the personal computer P, and stores an invalidated state flag having, for example, a value “01” if the content is in a “locked state” described later at the terminal device D and the personal computer P. Further, the flash ROM 103 stores an invalidated state flag having, for example, a value “10” if the terminal device D per se is in the “operation invalidated state” described later, and stores an invalidated state flag having, for example, a value “11” if the terminal device D per se is in a “completely invalidated state” described later.

Herein, the “lock released state” is a state in which normal operations of the terminal device D or the personal computer P, such as content display operations, are allowed, without limiting the content display operations for the display unit 106 of the terminal device D or for the display unit 11 of the personal computer P. The “locked state” is a state which requires a password authentication described later for displaying a confidential content at the terminal device D or the personal computer P. In other words, the locked state is a state which limits operations such as a display, change or deletion to the confidential content to which the operations is to be limited (to be kept secret) at the terminal device D and the personal computer P.

The “operation invalidated state” of the embodiment is a sate in which the terminal device D does not respond to (functions in response to) every operation executed using the manipulation keys 105. In the “operation invalidated state,” only when the personal computer P mutually authenticated with the terminal device D is connected to the terminal device D, a control from the personal computer P to the terminal device D is permitted.

The “completely invalidated state” is a state in which the terminal device D does not respond to every operation executed using the manipulation keys 105, and also in which even when the personal computer P is mutually authenticated with the terminal device D, a connection of the personal computer P to the terminal device D is refused by the terminal device D. Once the terminal device D is moved to the “completely invalidated state,” the terminal device D can not return to the “lock released state,” for example, unless the terminal device D is brought in the manufacturer, as in the Background art.

Control for the above described four states (including moving to each state) is performed by the invalidation unit 101a in the terminal device D with reference to a content of the invalidated state flag at the time.

The flash ROM 103 also stores identification information so as to identify the personal computer P which has been authenticated from other personal computer P in a nonvolatile manner.

The terminal device D further includes a battery 108, a charging controller 109, a memory card I/F 110, and a communication I/F 111. The battery 108 includes, for example, a lithium ion battery or the like. The charging controller 109 controls charging for the battery 108. The memory card I/F 110 is an example of a reading unit and includes a memory card drive or the like and performs data write and read for a memory card MC inserted to the memory card drive based on an instruction from the CPU 101. The communication I/F 111 performs an interface process for transmitting and receiving data by connecting the terminal device D with the personal computer P through the network NT. The CPU 101 is connected through a bus 112 to the ROM 102, the flash ROM 103, the RAM 104, the manipulation keys 105, the display controller 107, the charging controller 109, the memory card I/F 110, and the communication I/F 111.

(II) Operation of Terminal Device

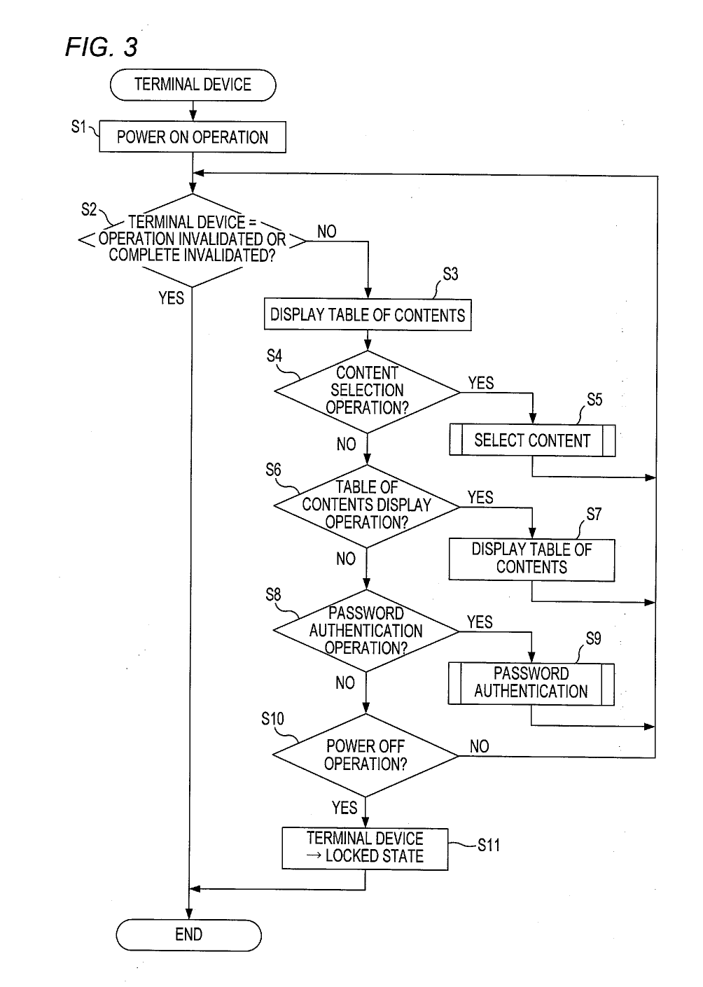

Next, the operations of each of the terminal device D and the personal computer P according to the embodiment will be described with reference to FIG. 3 to FIG. 6.

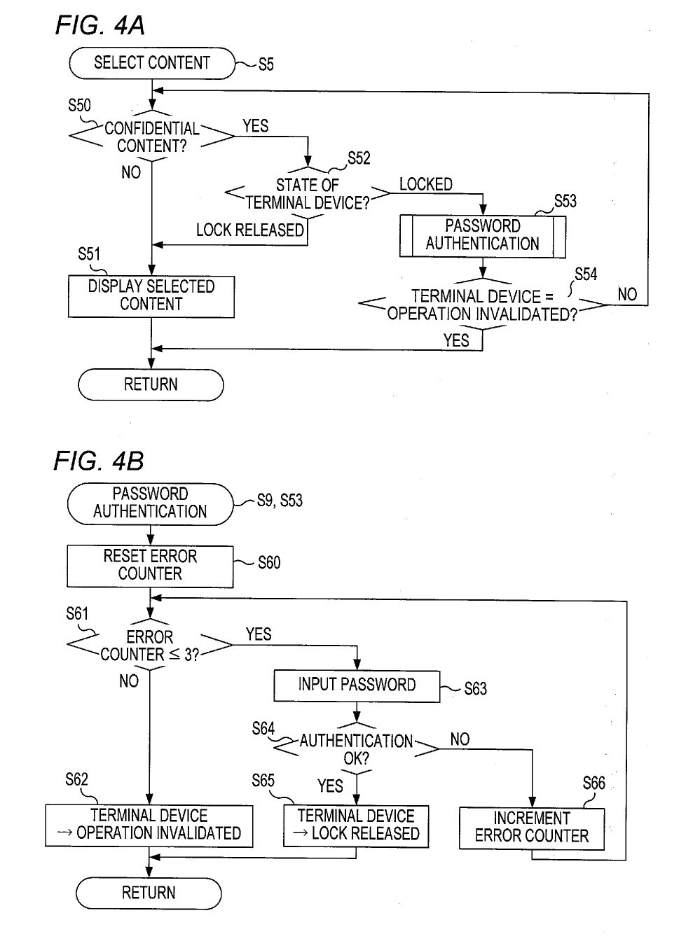

At first, the operation of the terminal device D according to the embodiment will be described with reference to FIG. 3 and FIGS. 4A and 4B.

As shown in FIG. 3, in the terminal device D of the embodiment, if the power switch 105f is operated (step S1), the CPU 101 references a content of the invalidated state flag stored in the flash ROM 103, and determines whether the value of the invalidated state flag indicates the “operation invalidated state” or the “completely invalidated state” (step S2). If the current value of the invalidated state flag indicates the “operation invalidated state” or the “completely invalidated state” (step S2: YES), the CPU 101 terminates the operation as the terminal device D in accordance with a definition of the “operation invalidated state” or the “completely invalidated state” as described above.

In the determination at step S2, if the value of the invalidated state flag does not indicate the “operation invalidated state” or the “completely invalidated state” (step S2: NO), the CPU 101 next displays a table or list of contents (hereinafter simply referred to as a table of contents) on the display unit 106 which is as a display target stored in the flash ROM 103 or the memory card MC the display unit 106 (step S3). Hereinafter, the flash ROM 103 or the memory card MC is simply referred to as the “flash ROM 103 etc.”

Next, the CPU 101 determines whether a selection operation using the table of contents already displayed (see step S3), an operation for re-display the table of contents, an operation for the password authentication, or a power-off operation using the power switch 105f is performed by using the manipulation keys 105, in this order (step S4, step S4: NO, step S6, step S6: NO, step S8, step S8: NO, and step S10).

In the determination at step S4, if any one of contents displayed in the table of contents is selected (step S4: YES), the CPU 101 executes an operation for selecting the selected content and displaying the selected content on the display unit 106, which is to be described later in detail (step S5). Thereafter, the CPU 101 returns to the determination operation of step S2.

In the determination at step S6, if the operation for re-display the table of contents is performed (step S6: YES), the CPU 101 displays the table of contents on the display unit 106 again in response to the operation (step S7), and then returns to the determination operation of step S2.

In the determination at step S8, if the operation for the password authentication is performed (step S8: YES), the CPU 101 performs a password authentication operation in response to the operation, which is to be described later in detail (step S9). Thereafter, the CPU 101 returns to the determination operation of step S2.

In the determination at step S10, if the power-off operation is performed by using the power switch 105f (step S10: YES), the invalidation unit 101a provided in the CPU 101 sets the display etc. of the confidential content on the terminal device D to the “locked state,” and stores this state as the invalidated state flag (step S11). Thereafter, the CPU 101 terminates the operation of the terminal device D.

Next, the selection/display operation of the content performed at step S5 will be described with reference to FIG. 4A.

As shown in FIG. 4A, as the selection/display operation, the CPU 101 determines whether the content selected by the operation at step S4 is a confidential content, by referencing a confidential flag (not shown) of the selected content (step S50). If the selected content is not a confidential content (step S50: NO), the CPU 101 displays the content on the display unit as a normal operation of the terminal device D (step S51), and the process proceeds to step S2 shown in FIG. 3.

If the content selected at the determination of step S50 is a confidential content (step S50: YES), the CPU 101 determines whether the display of the confidential content on the terminal device D is permitted at the time, by referencing the invalidated state flag (step S52). Accordingly, if it is determined that the state of the terminal device D is the “lock released state” (step S52: Lock Released), the CPU 101 determines that the terminal device D is in a state operated by a correct user, and even when the content is a confidential content, the CPU 101 displays the content on the display unit 106 (step S51), and the process proceeds to step S2 shown in FIG. 3.

At step S52, if it is determined that the state of the terminal device D is the locked state (step S52: locked), the CPU 101 determines that the terminal device D may be operated by one other than the correct user, and the process proceeds to an password authentication operation described later (step S53).

Next, the CPU 101 references the invalidated state flag and determines whether the state of the terminal device D at this time is the “operation invalidated state” (step S54). If it is determined that the state of the terminal device D is the “operation invalidated state” (step S54: YES), the CPU 101 proceeds to an operation of step S2 shown in FIG. 3. If it is determined at step S54 that the state of the terminal device D is not the “operation invalidated state” (step S54: NO), the CPU 101 proceeds to the operation of step S50.

Next, the password authentication operation performed at step S9 of FIG. 3 or step S53 will be described with reference to FIG. 4B.

As shown in FIG. 4B, in the password authentication operation, the CPU 101 resets an error counter associated with the password authentication (step S60). The error counter is a counter for counting a number of re-entry of the password information caused by a case in which password information input on a password input screen described later is different from correct password information stored, for example, in the flash ROM 103. The error counter is provided in the CPU 101. In the terminal device D of this embodiment, the maximum number of re-entry of the password information is three, but it is not limited thereto.

After the rest of the error counter is completed, the CPU 101 determines whether a current value of the error counter is three or less (step S61). If the value exceeds three (step S61: NO), input errors of the password information exceed predetermined times, and the CPU 101 determines that the terminal device D may be operated by a person other than the correct user at this time. Accordingly, the invalidation unit 101a provided in the CPU 101 sets the terminal device D to the “operation invalidated state” and stores the setting as the invalidated state flag in the flash ROM 103 (step S62). Thereafter, the CPU 101 proceeds to the operation of step S2 of FIG. 3 or step S53 of FIG. 4A.

In the determination of step S61, if the current value of the error counter is three or less (step S61: YES), the CPU 101 displays an image preset for password input on the display unit 106, and allows an input of password information using the image (step S63). Thereafter, the CPU 101 determines whether the input password information matches the correct password information (step S64). If the two pieces of password information match each other, the authentication is completed (succeeded) (step S64: YES). Then, the releasing unit 101b provided in the CPU 101 sets the terminal device D to the “lock released state” and stores the setting as the invalidated state flag in the flash ROM 103 (step S65). Thereafter, the CPU 101 proceeds to the operation of step S2 of FIG. 3 or step S53 of FIG. 4A.

In the determination of step S64, if the input password information does not match the correct password information, the authentication is failed (step S64: NO), and the CPU 101 increments the value of the error counter by one (step S66), and returns to the operation of step S61.

(III) Operation of Personal Computer

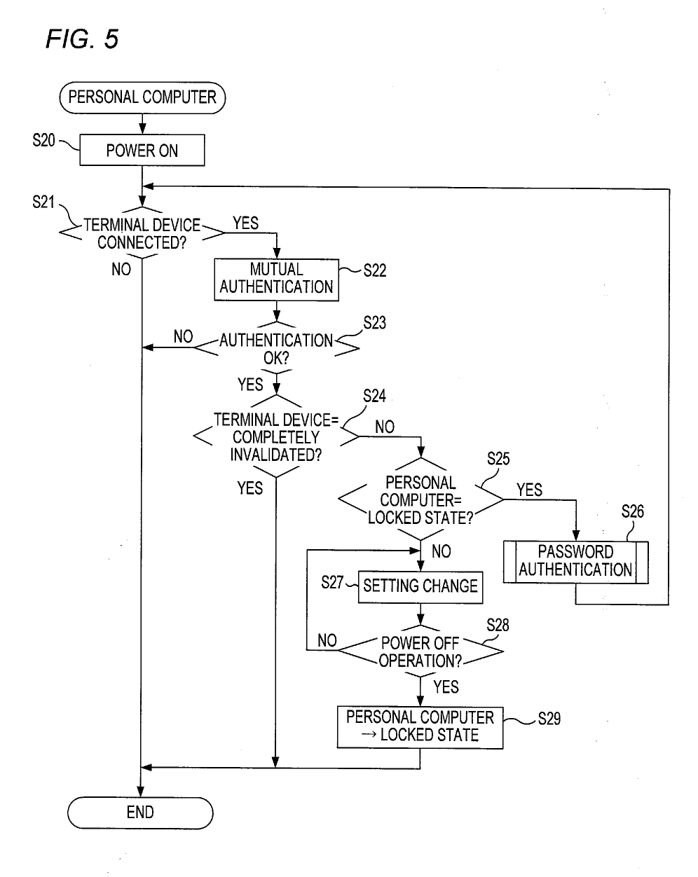

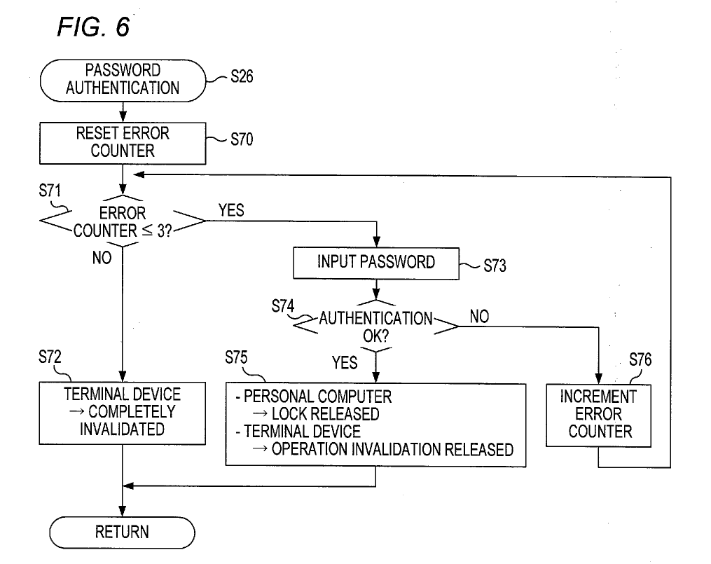

Next, the operation of the personal computer P according to the embodiment is described with reference to FIG. 5 and FIG. 6.

As shown in FIG. 5, in the personal computer P according to the embodiment, if the power is turned on (step S20), the CPU 10 determines that the terminal device D is connected to the personal computer P through the network NT (step S21). If the connection is not confirmed (step S21: NO), the CPU 10 terminates the operation of the personal computer P.

In the determination of step S21, if it is determined that the terminal device D is connected to the personal computer P (step S21: YES), the CPU 10 performs an authentication operation to the connected terminal device D (step S22).

As a specific authentication operation, the CPU 10 transmits identification information for identifying the personal computer P from other personal computer P to the terminal device D, so as to allow the CPU 101 of the terminal device D to compare the transmitted identification information with the identification information for identifying the authenticated personal computer P stored in the flash ROM 103. If both the identification information match each other, the mutual authentication between the personal computer P and the terminal device D which are currently connected is completed (succeeded). In contrast, if the both identification information do not match, the mutual authentication is uncompleted.

Next, the CPU 10 determines whether the mutual authentication at step S22 is completed (step S23). If the mutual authentication is not completed (step S23: NO), the CPU 10 determines that the terminal device D currently connected to the personal computer P is an incorrect (unauthenticated) terminal device with respect to the personal computer P, and terminates the operation of the personal computer P.

In the determination of step S23, if it is determined that the mutual authentication at step S22 is completed (step S23: YES), the determination unit 10a provided in the CPU 10 references a content of the invalidated state flag stored in the flash ROM 103 of the terminal device D, and determines whether the value of the invalidated state flag indicates the “completely invalidated state” (step S24). If the current value of the invalidated state flag indicates the “completely invalidated state” (step S24: YES), the personal computer P is no longer able to control the terminal device D, and consequently the CPU 10 terminates the operation of the personal computer P.

In the determination of step S24, if the current value of the invalidated state flag stored in the terminal device D does not indicate the “completely invalidated state” (step S24: NO), the determination unit 10a next determines whether the display etc. of the confidential content is in the “locked state” at the personal computer P (step S25).

If the personal computer P is in the locked state (step S25: YES), the CPU 10 performs a password authentication operation to be described later in detail, such that a setting state of the terminal device D can be changed by a control of the personal computer P (step S26). Thereafter, the CPU 10 proceeds to the operation of step S21.

In the determination of step S25, if the personal computer P is not in the “locked state” (step S25: NO), the CPU 10 transmits instruction information (e.g. command) to the CPU 101 of the terminal device so as to allow the personal computer P to change the setting state of the terminal device D (step S27).

Here, as a content of a change of the setting state, for example, a change of the password stored in the flash ROM 103 of the terminal device D, and/or a change of the identification information for identifying the authenticated personal computer P (see step S22).

Thereafter, the CPU 10 determines whether the operation for turning off the power of the personal computer P is performed by the manipulation unit 16 (step S28). If the operation is not performed (step S28: NO), the CPU 10 returns to step S27 and waits. If the operation is performed (step S28: YES), the CPU 10 moves the personal computer P to the “locked state” so as to ensure the security of the content in the personal computer P. Thereafter, the CPU 10 proceeds to the operation of step S21 shown in FIG. 5.

In the operation of step S28, it is determined whether the operation for turning off the personal computer P is performed. Instead, it may be determined whether the operation for stop a program for executing the operations shown in FIGS. 5 and 6, and the personal computer P itself may be operated with the power ON.

Next, the password authentication operation (of the personal computer P) executed as the operation of step S26 will be described with reference to FIG. 6.

As shown in FIG. 6, in the password authentication, at first, the CPU 10 resets an error counter in association with the password authentication (step S70). The error counter is, similar to the error counter in the CPU 101 of the terminal device D, a counter for counting a number of re-entry of the password information caused by a case in which password information input on a password input screen described later is different from correct password information stored, for example, in the ROM 14. The error counter is provided in the CPU 10. In the personal computer P of this embodiment, the maximum number of re-entry of the password information is three similar to the terminal device D, but it is not limited thereto.

After the rest of the error counter is completed, the CPU 10 determines whether a current value of the error counter is three or less (step S71). If the value exceeds three (step S71: NO), input errors of the password information exceed predetermined times, and the CPU 10 determines that the personal computer P may be operated by a person other than the correct user at this time. Accordingly, the invalidation unit 10c provided in the CPU 10 controls the invalidation unit 101a provided in the terminal device D so as to set the terminal device D to the “completely invalidated state” to ensure the security of the content in the terminal device D, and stores the setting as the invalidated state flag in the flash ROM 103 (step S72). Thereafter, the CPU 10 proceeds to the operation of step S21 of FIG. 5.

In the determination of step S71, if the current value of the error counter is three or less (step S71: YES), the CPU 10 displays an image preset for password input on the display unit 11, and allows an input of password information using the image (step S73). Thereafter, the CPU 10 determines whether the input password information matches the correct password information stored in the ROM 14 (step S74). If the two pieces of password information match each other, the authentication is completed (succeeded) (step S74: YES). Then, the releasing unit 10b provided in the CPU 10 sets the display etc. of the confidential content on the personal computer P to the “lock released state,” controls the releasing unit 101b of the terminal device D so as to release the “operation invalidated state” in the terminal device D, and stores the setting as the invalidated state flag in the flash ROM 103 (step S75). Thereafter, the CPU 101 proceeds to the operation of step S21 of FIG. 5.

In the determination of step S74, if the input password information does not match the correct password information stored in the ROM 14, the authentication is failed (step S74: NO), and the CPU 10 increments the value of the error counter by one (step S76), and returns to the operation of step S71.

The password authentication operation at step S26 of FIG. 5 is performed in a case in which the personal computer P controls the invalided state of the terminal device D. Instead, the password authentication operation may be required at the personal computer P in advance of storing the confidential content in the memory card MC. That is, when the content is stored in the memory card MC, it is preferable to perform, in advance, an operation similar to the password authentication operation of step S26.

In the operations of step S71, S73, S74 and S76, the terminal device D is not in the completely invalidated state until the incorrect password information is input three times at the password authentication operation (step S71: NO, and step S72). However, the password authentication operation may be allowed to be suspended. In this case, the number of re-entry of the password information before the suspension may be stored, and the stored value may be reset at performing the operation of step S75.

As described above, according to the operation of the information management system S of the embodiment, when the personal computer P set the display etc. of the confidential content on the terminal device D to the “lock released state,” the personal computer P also release the invalidation of the operation at the terminal device D. Consequently, it is not necessary to bring the terminal device D in the manufacturer only for releasing the invalidation of the operation at the terminal device D, or to provide a dedicated device for releasing the invalidation. Therefore, the convenience can be improved.

Accordingly, even when the terminal device D is a portable device carried by the user, the “operation invalidated state” can easily be released, and the convenience of the terminal device D can be improved.

When the operation to the terminal device D connected to the network NT is invalidated, the invalidated state of the terminal device can be released by only a release control from the personal computer P. Therefore, the convenience for the user can be improved.

Further, if the password authentication at the personal computer P can not be correctly performed, the state of the terminal device D is changed to the “completely invalidated state” such that entire connection of the terminal device to an external is refused. Therefore, for example, if the personal computer P is improperly used, the security of the content in the terminal device D can be ensured.

(IV) Modifications

Next, modifications of the embodiment will be described.

In the embodiment described above, the personal computer P and the terminal device D are connected through the network NT, and the personal computer P directly controls the state of the terminal device D through the network NT. However, the present invention is not limited thereto, and even when the personal computer P and the terminal device D are not directly connected, the similar operations of the embodiment can be performed through the use of the memory card MC.

Specifically, the CPU 101 of the terminal device D stores the invalidated state flag indicating the current state of the terminal device D in the memory card MC. Then, the CPU 10 of the personal computer P reads the content stored in the memory card MC through the memory card I/F 13 at the timing corresponding to the operation of step S24 or S25 of FIG. 5, and recognizes the state of the terminal device D.

Next, the CPU 10 of the personal computer P stores a command and identification information in the memory card MC at a timing corresponding to the operation of step S29 of FIG. 5. The command is for setting the display etc. of the confidential content on the terminal device D to the “locked state.” The identification information is for identifying the personal computer P. Further, the CPU 10 writes the content of the invalidated state flag in the memory card MC to indicate the “locked state.” When the stored content of the memory card MC is read by the CPU 101 of the terminal device D through the memory card I/F 110, the invalidation unit 101a sets the display etc. of the confidential content on the terminal device D to the “locked state” in accordance with the stored content. In the subsequent control of the terminal device D, the CPU 101 performs the control in accordance with the invalidated state flag stored in the memory card MC.

Similarly, the CPU 10 stores a command at a timing corresponding to the operation of step S72 of FIG. 6 in the memory card MC. The command is for setting the terminal device D to the “completely invalidated state” (in case of step S72) or for releasing the “operation invalidated state” (in case of step S75). The CPU 10 also rewrites the content of the invalidated state flag in the memory card MC to indicate the “completely invalidated state” (in case of step S72) or to indicate release of the “operation invalidated state” (in case of step S75). When the stored content of the memory card MC is read by the CPU 101 of the terminal device D through the memory card I/F 110, the invalidation unit 101a or the releasing unit 101b sets the terminal device D to the “completely invalidated state” (in case of step S72) or a released state of the “operation invalidated state” (in case of step S75) in accordance with the stored content.

According to the operation of the information management system according to the modifications described above, if the operation to the terminal device D is invalidated, the personal computer P reads the identification information of the personal computer P and a command etc. for releasing the invalidation or for setting the completely invalidation etc. from the memory card MC storing the command etc, and releases the invalidated state of the terminal device D. Consequently, similar to the information management system S of the embodiment, it is possible to ensure the security of the content at the terminal device D and also to improve the convenience of the user.

In the above-described embodiments, the terminal device D as a whole is set to the invalidated state. However, it is not limited thereto. For example, the invalidated state may be applied to individual content (target information) stored in the terminal device D or may be applied to a content group including a plurality of contents. In this case, change of settings for the individual content or the content group may be performed by the terminal device D or the personal computer P only when the setting is in the “lock released state.” Further, the change of setting may be performed by the personal computer P only, which can clarify who has a management authority.

Further, the correct password information to be input at step S9 of FIG. 3, step S26 of FIG. 5, and step S53 of FIG. 4A may be the same information or may be different from one another.

Further, programs corresponding to the flowcharts each shown in FIGS. 3-6 or programs obtained through a network such as the Internet may be stored in a recording medium such as a flexible disk, and then, may be read and executed by a computer such as a microcomputer, and thus, the computer can serve as the CPU 10 or the CPU 101 according to the embodiments and the modifications.

As described above, the invention can be applied to the field of information management systems, and particularly, can be effectively applied to a management of security in case of storing the confidential content in the terminal device D which can be carried as a portable device.

What is claimed is:

1. An information management system comprising:
a first information processing apparatus; and
a second information processing apparatus,
wherein the first information processing apparatus comprises:
a storage unit configured to store: target information which is a target of a process at the first information processing apparatus; and invalidation information which indicates whether an operation performed at the first information processing apparatus is invalidated at the first information processing apparatus;
a first input unit configured to receive an input of terminal password information;
an invalidation unit configured to invalidate the operation performed at the first information processing apparatus if the input terminal password information is different from correct terminal password information; and
a first releasing unit configured to release an invalidation of the operation in a case in which the operation is invalidated by the invalidation unit, based on an invalidation releasing process performed by the second information processing apparatus, and
wherein the second information processing apparatus comprises:
a determination unit configured to obtain the invalidation information stored in the first information processing apparatus, and to determine whether the target information is in a limited state based on the obtained invalidation information, the limited state in which the process to the target information is limited at the second information processing apparatus;
a second input unit configured to receive an input of a limitation releasing password information for releasing the limited state when the target information is in the limited state; and
a second releasing unit configured to perform the invalidation releasing process if correct limitation releasing password information is input; the invalidation releasing process comprising:
a limited state releasing process for releasing the limited state of the target information; and
an operation invalidation releasing process for releasing the invalidation of the operation of the first information processing apparatus when the operation is invalidated.

2. The information management system according to claim 1,
wherein the terminal password information is terminal password information to be input by the first input unit so as to release a second limited state in which the process to the target information is limited at the first information processing apparatus, when the target information is in the second limited state.

3. The information management system according to claim 1,
wherein the first information processing apparatus and the second information processing apparatus are connected with each other through a network,
wherein the first releasing unit releases the invalidation of the operation based on releasing information obtained from the second information processing apparatus,
wherein the second releasing unit performs the operation invalidation releasing process by transmitting the releasing information indicating an execution of the operation invalidation releasing process to the first information processing apparatus via the network.

4. The information management system according to claim 1,
wherein the storage unit of the first information processing apparatus comprises:
a fixed storage unit configured to store the terminal password information;
a recording medium configured to store the target information and the invalidation information; and
a reading unit configured to read the target information and the invalidation information from the recording medium,
wherein the first releasing unit releases the invalidation of the operation in response to the invalidation information on the invalidation releasing process when the operation is invalided, and
wherein the second releasing unit performs an invalidation information changing process as the operation invalidation releasing process, so as to set the invalidation information stored in the recording medium to indicate that the operation performed at the first information processing apparatus is not invalidated at the first information processing apparatus.

5. The information management system according to claim 1,
wherein the second information processing apparatus further comprises:
a second storage unit configured to store invalidation releasing password information for releasing the invalidation of the operation at the first information processing apparatus;
an input unit configured to receive an input of invalidation releasing password information; and
a refusal instruction unit configured to allow the first information processing apparatus to obtain connection refusal instruction information, if the invalidation releasing password information input from the input unit is different from the invalidation releasing password information stored in the second storage unit, and
wherein the first information processing apparatus further comprises:
a state changing unit configured to set the first information processing apparatus to a connection refusal state in which a connection between the first information processing apparatus and an external is entirely refused, if the first information processing apparatus obtains the connection refusal instruction information.

6. The information management system according to claim 1,
wherein the first information processing apparatus and the second information processing apparatus are authenticated to each other.

7. A second information processing apparatus provided in an information management system that comprises a first information processing apparatus and the second information processing apparatus, said second information processing apparatus comprising:
a determination unit configured to obtain invalidation information which indicates whether an operation performed at the first information processing apparatus is invalidated at the first information processing apparatus and which is stored in the first information processing apparatus, and to determine whether target information which is stored in the first information processing apparatus and which is a target of a process at the first information processing apparatus is in a limited state based on the obtained invalidation information, the limited state in which the process to the target information is limited at the second information processing apparatus; and
a second releasing unit configured to perform an invalidation releasing process if correct limitation releasing password information for releasing the limited state when the target information is in the limited state is input, the invalidation releasing process comprising:
a limited state releasing process for releasing the limited state of the target information; and
an operation invalidation releasing process for releasing the invalidation of the operation of the first information processing apparatus when the operation is invalidated.

8. A first information processing apparatus provided in an information management system that comprises the first information processing apparatus and a second information processing apparatus, said first information processing apparatus comprising:
a storage unit configured to store: target information which is a target of a process at the first information processing apparatus; and invalidation information which indicates whether an operation performed at the first information processing apparatus is invalidated at the first information processing apparatus;
a first input unit configured to receive an input of terminal password information;
an invalidation unit configured to invalidate the operation performed at the first information processing apparatus if the input terminal password information is different from correct terminal password information; and
a first releasing unit configured to release an invalidation of the operation in a case in which the operation is invalidated by the invalidation unit, based on an invalidation releasing process performed by the second information processing apparatus.

9. A computer readable medium having an information processing program for a second information processing apparatus provided in an information management system that comprises a first information processing apparatus and the second information processing apparatus, said program being stored on the computer readable medium, readable by a computer, and when executed by the computer, causing the computer to perform operations comprising:
obtaining invalidation information which is stored in the first information processing apparatus and which indicates whether an operation performed at the first information processing apparatus is invalidated at the first information processing apparatus, and determining whether target information which is stored in the first information processing apparatus and which is a target of a process at the first information processing apparatus is in a limited state based on the obtained invalidation information, the limited state in which the process to the target information is limited at the second information processing apparatus; and
performing an invalidation releasing process if correct limitation releasing password information for releasing the limited state when the target information is in the limited state is input,
wherein the invalidation releasing process comprising:
performing a limited state releasing process for releasing the limited state of the target information; and
performing an operation invalidation releasing process for releasing the invalidation of the operation of the first information processing apparatus when the operation is invalidated.

10. A computer readable medium having an information processing program for a first information processing apparatus which is provided in an information management system comprising the first information processing apparatus and a second information processing apparatus and which comprises a storage unit configured to store target information being a target of a process at the first information processing apparatus and invalidation information indicating whether an operation performed at the first information processing apparatus is invalidated at the first information processing apparatus and a first input unit, said program being stored on the computer readable medium, readable by a computer, and when executed by the computer, causing the computer to perform operations comprising:
invalidating the operation performed at the first information processing apparatus if terminal password information input to the first input unit is different from correct terminal password information; and
releasing an invalidation of the operation in a case in which the operation is invalidated, based on an invalidation releasing process performed by the second information processing apparatus.
